(19) United States
(12) Patent Application Publication
(10) Pub. No.: US 2019/0164566 A1
(43) Pub. Date: May 30, 2019

(54) EMOTION RECOGNIZING SYSTEM AND METHOD, AND SMART ROBOT USING THE SAME

(71) Applicant: AROBOT INNOVATION CO., LTD., NEW TAIPEI CITY (TW)

(72) Inventors: ROU-WEN WANG, CHANGHUA COUNTY (TW); HUNG-PIN KUO, NEW TAIPEI CITY (TW); YUNG-HSING YIN, NEW TAIPEI CITY (TW)

(21) Appl. No.: 15/864,646

(22) Filed: Jan. 8, 2018

(30) Foreign Application Priority Data
Nov. 29, 2017 (TW) 106141610

(51) Int. Cl. G10L 25/63; G06F 17/30; G10L 17/22; G10L 17/06; G10L 17/26; B25J 11/00; B25J 9/16

(52) U.S. Cl. CPC G10L 25/63; G06F 17/30743; G10L 17/22; B25J 9/0003; G10L 17/26; B25J 11/0005; B25J 9/1694; G10L 17/06

(57) ABSTRACT

Disclosed are an emotion recognizing system, an emotion recognizing method and a smart robot. They recognize a user's emotional state according to a voice signal by steps as follows: processing the voice signal to obtain a voiceprint file, and recognizing the identification of an individual that transmits the voice signal according to the voiceprint file; determining whether a completion percentage of the personal emotion database corresponding to the identification of the individual is larger than or equal to a predetermined percentage; comparing the voiceprint file with a preset voiceprint to capture a plurality of characteristic values; comparing the characteristic values with sets of sample characteristic values in the personal emotion database or in the built-in emotion database and determining the emotional state; and storing a relationship between the characteristic values and the emotional state in the personal emotion database and the built-in emotion database.

### BACKGROUND OF THE INVENTION

### 1. Field of the Invention

The present disclosure relates to an emotion recognizing system, an emotion recognizing method and a smart robot using the same; in particular, to an emotion recognizing system, an emotion recognizing method and a smart robot using the same that can recognize an emotional state according to a voice signal.

### 2. Description of Related Art

Generally, a robot refers to a machine that can automatically execute an assigned task. Some robots are controlled by simple logic circuits, and some robots are controller by high-level computer programs. Thus, a robot is usually a device with mechatronics integration. In recent years, the technologies relevant to robots are well developed, and robots for different uses are invented, such as industrial robots, service robots, and the like.

Modern people value convenience very much, and thus service robots are accepted by more and more people. There are many kinds of service robots for different applications, such as professional service robots, personal/domestic use robots and the like. These service robots need to communicate and interact with users, so they should be equipped with abilities for detecting the surroundings. Generally, the service robots can recognize what a user says means, and accordingly provides a service to the user or interacts with the user. However, usually they can only provide a service to the user or interact with the user according to an instruction (i.e., what the user says), but cannot provide a more thoughtful service to the user or interact with the user according to what the user says and how the user feels.

### SUMMARY OF THE INVENTION

To overcome the above disadvantages, the present disclosure provides an emotion recognizing system, an emotion recognizing method and a smart robot using the same that can recognize an emotional state according to a voice signal.

The emotion recognizing system provided by the present disclosure includes an audios receiver, a memory and a processor, and the processor is connected to the audio receiver and the memory. The audio receiver receives the voice signal. The memory stores a recognition program, a built-in emotion database, a plurality of personal emotion databases and a preset voiceprint database. It should be noted that, different personal emotion databases correspond to different individuals. In addition, the preset voiceprint database stores a plurality of sample voiceprint and relationship between the sample voiceprint and identifications of different individuals. The processor executes the recognition program to process the voice signal for obtaining a voiceprint file, recognize the identification of an individual that transmits the voice signal according to the voiceprint file, and determine whether a completion percentage of the personal emotion database corresponding to the identification of the individual is larger than or equal to a predetermined percentage. Further, the processor executes the recognition program to compare the voiceprint file with a preset voiceprint to capture a plurality of characteristic values, and compare the characteristic values with sets of sample characteristic values in the personal emotion database or in the build-in emotion database and determine the emotional state. Finally, the processor executes the recognition program to store a relationship between the characteristic values and the emotional state in the personal emotion database and the build-in emotion database.

It should be noted that, the voiceprint file will be recognized according to the personal emotion database if the completion percentage of the personal emotion database corresponding to the identification of the individual is larger than or equal to the predetermined percentage, and the voiceprint file will be recognized according to the built-in emotion database if the completion percentage of the personal emotion database corresponding to the identification of the individual is smaller than or equal to the predetermined percentage. It should be also noted that, different sets of the sample characteristic values correspond to different emotional states.

The emotion recognizing method provided by the present disclosure is adapted to the above emotion recognizing system. Specifically, the emotion recognizing method provided by the present disclosure is implemented by the recognition program in the above emotion recognizing system. Moreover, the smart robot provided by the present disclosure includes a CPU and the above emotion recognizing system, so that the smart robot can recognize an emotional state according to a voice signal. Additionally, the CPU can generate a control instruction according to the emotional state recognized by the emotion recognizing system, such that the smart robot will execute a task according to the control instruction.

By using the emotion recognizing system and the emotion recognizing method provided by the present disclosure, a user's current emotional state can be recognized, so the smart robot provided by the present disclosure can provide a service to the user or interact with the user based on the user's command and the user's current emotional state. Comparing with robot devices that can only provide a service to the user or interact with the user based on the user's command, services and responses provided by the smart robot in the present disclosure are much more touching and thoughtful.

For further understanding of the present disclosure, reference is made to the following detailed description illustrating the embodiments of the present disclosure. The description is only for illustrating the present disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of an emotion recognizing system according to one embodiment of the present disclosure;

FIG. 2 shows a flow chart of an emotion recognizing method according to one embodiment of the present disclosure; and

FIG. 3A and FIG. 3B show flow charts of an emotion recognizing method according to anther embodiment of the present disclosure.

### DETAILED DESCRIPTION OF EXEMPLARY EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings. In these drawings, like references indicate similar elements.

It will be understood that, although the terms first, second, third, and the like, may be used herein to describe various elements, these elements should not be limited by these terms. These terms are only to distinguish one element from another element, and the first element discussed below could be termed a second element without departing from the teachings of the instant disclosure. As used herein, the term “and/or” includes any and all combinations of one or more of the associated listed items.

[One Embodiment of the Emotion Recognizing System]

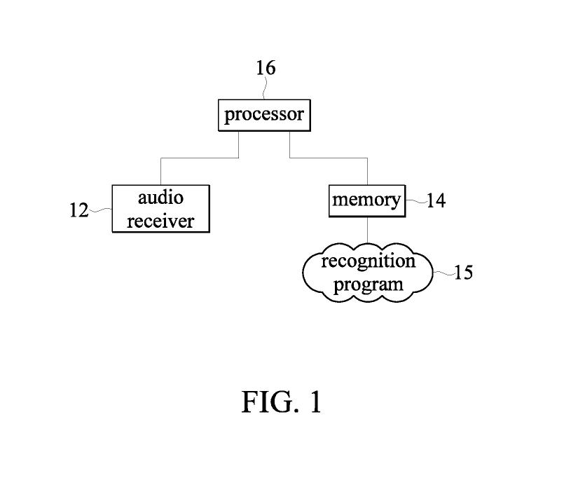

The structure of the emotion recognizing system in this embodiment is described in the following descriptions. Referring to FIG. 1, a block diagram of an emotion recognizing system according to one embodiment of the present disclosure is shown.

As shown in FIG. 1, the emotion recognizing system includes an audio receiver 12, a memory 14 and a processor 16. The audio receiver 12 is configured to receive a voice signal. The memory 14 is configured to store a recognition program 15, a built-in emotion database, a plurality of personal emotion databases and a preset voiceprint database. The audio receiver 12 can be implemented by a microphone device, and the memory 14 and the processor 16 can be implemented by firmware or by any proper hardware, firmware, software and/or the combination thereof.

It should be noted that, the personal emotion databases in the memory 14 respectively correspond to identifications of different individuals. The relationships between emotional states and sample characteristic values are stored in the personal emotion database for each specific individual. In the personal emotion database, one set of sample characteristic values corresponds to one emotional state, but different sets of sample characteristic values may correspond to the same emotional state. In addition, relationships between emotional states and sample characteristic values are stored in the built-in emotion database for general users. In the built-in emotion database, one set of sample characteristic values corresponds to one emotional state, but different sets of sample characteristic values may correspond to the same emotional state. Specifically, the relationships between emotional states and sample characteristic values stored in the built-in emotion database are collected by a system designer from general users. Moreover, relationships between the sample voiceprints and identifications of different individuals are stored in the preset voiceprint database.

[One Embodiment of the Emotion Recognizing Method]

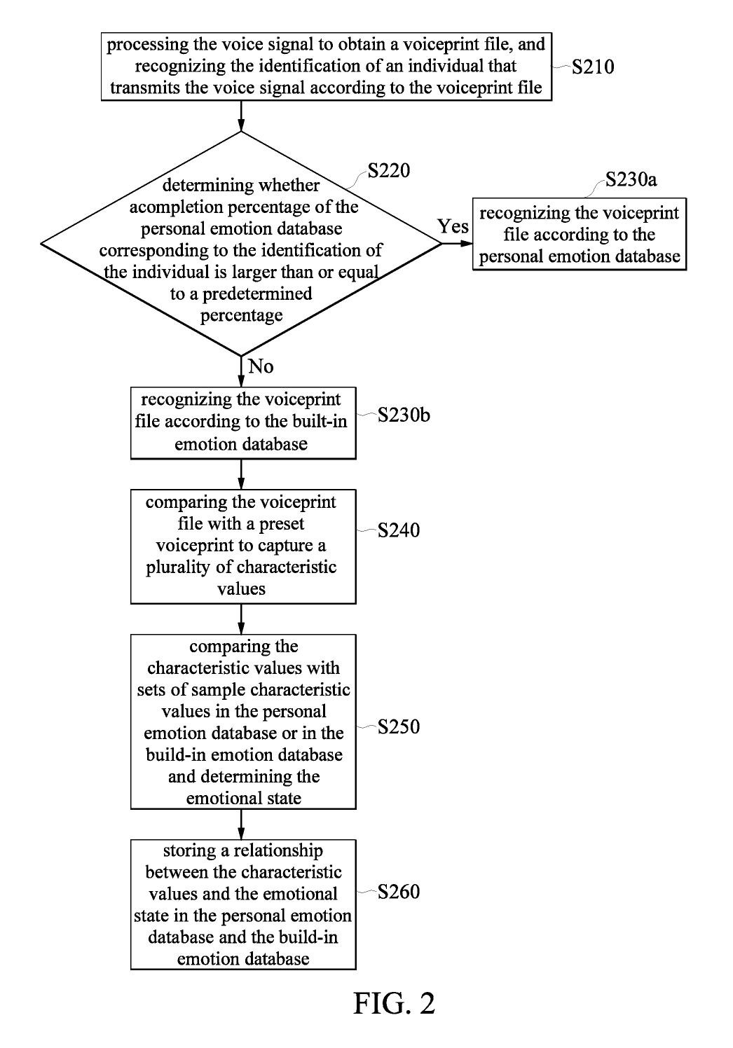

Referring to FIG. 2, a flow chart of an emotion recognizing method according to one embodiment of the present disclosure is shown.

The emotion recognizing method in this embodiment is implemented by the recognition program 15 in the memory 14. The processor 16 of the emotion recognizing system shown in FIG. 1 executes the recognition program 15 to implement the emotion recognizing method in this embodiment. Thus, FIG. 1 and FIG. 2 help to understand the emotion recognizing method in this embodiment. As shown in FIG. 2, the emotion recognizing method majorly includes the following steps: processing the voice signal to obtain a voiceprint file, and recognizing the identification of an individual that transmits the voice signal according to the voiceprint file (step S210); determining whether a completion percentage of the personal emotion database corresponding to the identification of the individual is larger than or equal to a predetermined percentage (step S220); recognizing the voiceprint file according to the personal emotion database (step S230); recognizing the voiceprint file according to the built-in emotion database (S230b); comparing the voiceprint file with a preset voiceprint to capture a plurality of characteristic values (step S240); comparing the characteristic values with sets of sample characteristic values in the personal emotion database or in the built-in emotion database and determining the emotional state, wherein different sets of the sample characteristic values correspond to different emotional states (step S250); and storing a relationship between the characteristic values and the emotional state in the personal emotion database and the built-in emotion database (step S260).

Details about each of the above steps are illustrated in the following descriptions.

After the audio receiver 12 receives a voice signal, in step S210, the processor 16 processes the voice signal to obtain a voiceprint file. For example, the processor 16 can convert the voice signal to a spectrogram for capturing characteristic values in the spectrogram as the voiceprint file. After that, the processor 16 can recognizes the identification of an individual that transmits the voice signal according to the voiceprint file through the preset voiceprint database.

After that, in step S220, the processor 16 finds a personal emotion database according to the identification of the individual, and then determines whether a completion percentage of the personal emotion database is larger than or equal to a predetermined percentage. When the completion percentage of the personal emotion database is larger than or equal to the predetermined percentage, the data amount and the data integrity of the personal emotion database are efficient so the data in the personal emotion database can be used for recognizing the voiceprint file. In this case, it goes to step S230a to recognize the voiceprint file according to the personal emotion database. On the other hand, when the completion percentage of the personal emotion database is smaller than the predetermined percentage, the data amount and the data integrity of the personal emotion database are inefficient so the data in the personal emotion database cannot be used for recognizing the voiceprint file. In this case, it goes to step S230b to recognize the voiceprint file according to the built-in emotion database.

After determining to recognize the voiceprint file by using the data in the personal emotion database or the data in the built-in emotion database, in the step S240, the processor 16 compares the voiceprint file with a preset voiceprint. It should be noted that, the preset voiceprint is previously stored in the built-in emotion database and in each personal emotion database. The preset voiceprint stored in each personal emotion database is obtained according to a voice signal transmitted by a specific individual who is clam, and the preset voiceprint stored in the built-in emotion database is obtained according to a voice signal transmitted by a general user who is calm. Thus, the processor 16 can capture a plurality of characteristic values that can be used to recognize the emotional state of the individual after comparing the voiceprint file with the preset voiceprint.

As mentioned, the relationships between emotional states and sample characteristic values are stored in the personal emotion database for each specific individual, and the relationships between emotional states and sample characteristic values are stored in the built-in emotion database for general users. In addition, in the built-in emotion database and each personal emotion database, one set of sample characteristic values correspond to one emotional state, but different sets of sample characteristic values may correspond to the same emotional state. Thus, in step S250, the processor 16 can determine the emotional state that the individual most probably has after comparing the captured characteristic values with sets of sample characteristic values in the personal emotion database or in the built-in emotion database.

It is worth mentioning that, in step S250, the processor 16 compares the captured characteristic values with sets of sample characteristic values in the personal emotion database or in the built-in emotion database by using a Search Algorithm, and then determines the emotional state that the individual most probably has. In other words, the processor 16 uses the Search Algorithm to find one set of sample characteristic values in the personal emotion database or in the built-in emotion database, and the found set of sample characteristic values are most similar to the captured characteristic values. For example, the Search Algorithm used by the processor 16 can be the Sequential Search Algorithm, the Binary Search Algorithm, the Tree Search Algorithm, the Interpolation Search Algorithm, the Hashing Search Algorithm and the like. The Search Algorithm used by the processor 16 is not restricted herein.

Finally, in step S260, the processor 16 stores a relationship between the characteristic values and the emotional state in the personal emotion database and the built-in emotion database. Specifically, the processor 16 groups the characteristic values as a new set of sample characteristic values and then stores the new set of sample characteristic values in the personal emotion database corresponding to the identification of the individual and the built-in emotion database. At the same time, the processor 16 stores a relationship between the emotional state and the new set of sample characteristic values in the personal emotion database and the built-in emotion database. Thus, the step S260 is considered a learning function of the emotion recognizing system. The data amount of the personal emotion database and the built-in emotion database can be increased, and the data integrity of the personal emotion database and the built-in emotion database can be improved.

[Another Embodiment of the Emotion Recognizing Method]

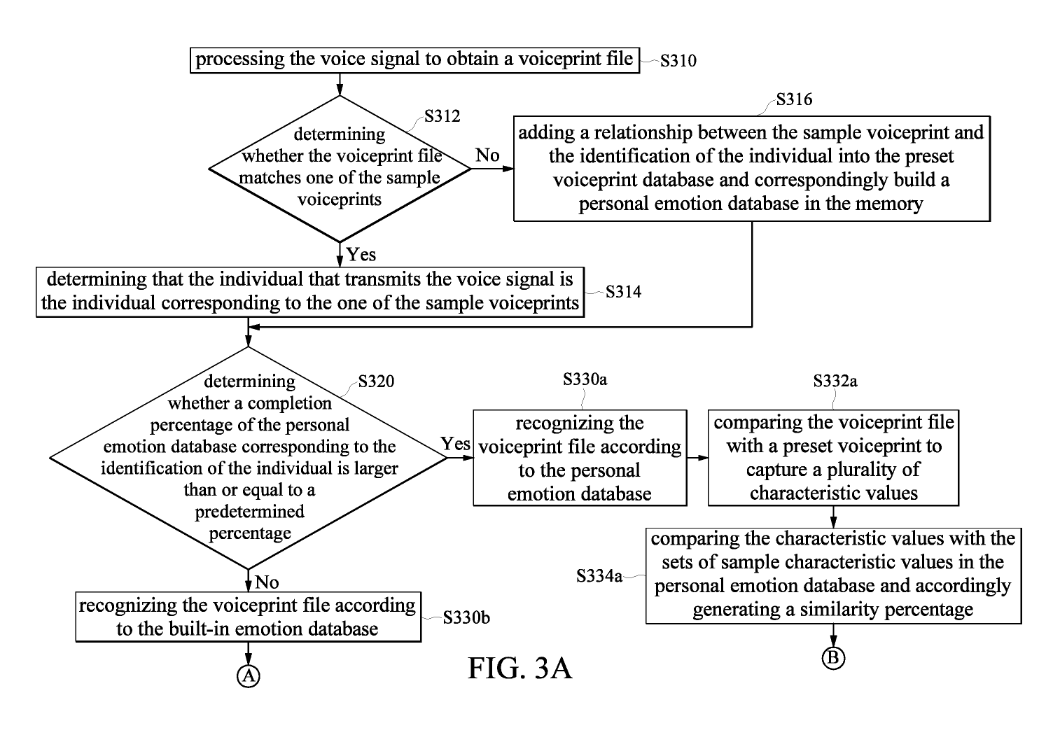

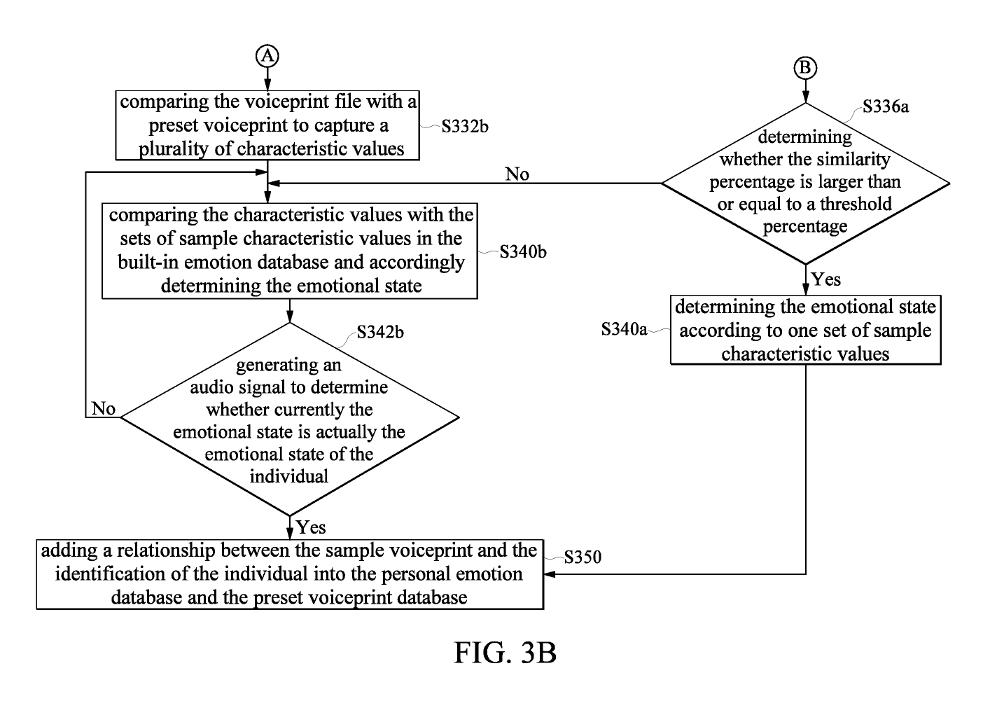

Referring to FIG. 3A and FIG. 3B, flow charts of an emotion recognizing method according to anther embodiment of the present disclosure is shown.

The emotion recognizing method in this embodiment is implemented by the recognition program 15 in the memory 14. The processor 16 of the emotion recognizing system shown in FIG. 1 executes the recognition program 15 to implement the emotion recognizing method in this embodiment. Thus, FIG. 1, FIG. 3A and FIG. 3B help to understand the emotion recognizing method in this embodiment.

The steps S320, S330a, S330b, S340a, S340b and S350 of the emotion recognizing method in this embodiment are similar to the steps S220˜S260 of the emotion recognizing method shown in FIG. 2. Thus, details about the steps S320, S330a, S330b, S340a, S340b and S350 of the emotion recognizing method in this embodiment are similar can be referred to the above descriptions of the steps S220˜S260 of the emotion recognizing method shown in FIG. 2. Only differences between the emotion recognizing method in this embodiment and the emotion recognizing method shown in FIG. 2 are described in the following descriptions.

After the audio receiver 12 receives a voice signal, in step S310, the processor 16 processes the voice signal to obtain a voiceprint file. For example, the processor 16 can convert the voice signal to a spectrogram for capturing characteristic values in the spectrogram as the voiceprint file. However, how the processor 16 processes the voice signal and obtains a voiceprint file is not restricted herein.

Different from the emotion recognizing method shown in FIG. 2, the emotion recognizing method in this embodiment further includes steps S312˜S316. Relationships between sample voiceprints and identifications of different individuals are stored in the preset voiceprint database, so in step S312, the processor 16 compares the voiceprint file with the sample voiceprints in the preset voiceprint database to determine whether the voiceprint file matches one of the sample voiceprints. For example, the processor 16 can determine whether the voiceprint file matches one of the sample voiceprints according to the similarity between the sample voiceprints and the voiceprint file. If the similarity between one of the sample voiceprints and the voiceprint file is larger than or equal to a preset percentage set by the system designer, the processor 16 determines that the sample voiceprint matches the voiceprint file.

After the processor 16 finds the sample voiceprint matching the voiceprint file, it goes to step S314 to determine whether the identification of the individual transmitting the voice signal is equal to the identification of the individual corresponding to the sample voiceprint. On the other hand, if the processor 16 finds no sample voiceprint matching the voiceprint file, it means that no sample voiceprint corresponding to the identification of the individual transmitting the voice signal in the preset voiceprint database. Thus, in step S316, the processor 16 takes the voiceprint file as a new sample voiceprint, and stores the new sample voiceprint and the relationship between the new sample voiceprint and the identification of the individual transmitting the voice signal in the preset voiceprint database. In addition, the processor 16 builds a new personal emotion database in the memory 14 for the individual transmitting the voice signal.

After determining the identification of the individual transmitting the voice signal, in steps S320, S330a and S330b, if there is a personal emotion database corresponding to the identification of the individual transmitting the voice signal in the memory 14, the processor 16 determines whether the completion percentage of the personal emotion database is larger than or equal to a predetermined percentage. If the completion percentage of the personal emotion database is larger than or equal to the predetermined percentage, the processor 16 chooses to use the personal emotion database for recognizing the voiceprint file; however, if the completion percentage of the personal emotion database is smaller than or equal to the predetermined percentage, the processor 16 chooses to use the built-in emotion database for recognizing the voiceprint file. On the other hand, there is no personal emotion database corresponding to the identification of the individual transmitting the voice signal, the processor 16 chooses to use the built-in emotion database for recognizing the voiceprint file.

Steps of how the processor 16 uses the personal emotion database corresponding to the identification of the individual transmitting the voice signal to recognize the voiceprint file are described in the following descriptions.

After choosing the personal emotion database corresponding to the identification of the individual transmitting the voice signal to recognize the voiceprint file, in step S332a, the processor 16 compares the voiceprint file with a preset voiceprint to capture a plurality of characteristic values. Step S332a is similar to step S240 of the emotion recognizing method shown in FIG. 2, so details about step S332a can be referred to the above descriptions relevant to step S240 of the emotion recognizing method shown in FIG. 2. After that, in step S334a, the processor 16 compares the captured characteristic values with sets of sample characteristic values in the personal emotion database and generates a similarity percentage. For example, the characteristic values the processor 16 captures from the voiceprint file can be the pitch, the formant, the frame energy and the like. The pitch is related to the sensation of human beings to the fundamental frequency, the formant is related to the frequency where the energy density is large in the voiceprint file, and the frame energy is related to the intensity variation of the voiceprint file. However, the types of the characteristic values the processor 16 captures from the voiceprint file are not restricted.

After that, in step S336a, the processor 16 determines whether the similarity percentage obtained in step S334a is larger than or equal to a threshold percentage. Specifically, the processor 16 determines whether there is one or more sets of sample characteristic values having a similarity percentage larger than or equal to the threshold percentage. If there is one set sample characteristic values having a similarity percentage larger than or equal to the threshold percentage, in step S340a, the processor 16 determines an emotional state according to the set of sample characteristic values. In addition, if there are more than one set of sample characteristic values having a similarity percentage larger than or equal to the threshold percentage, in step S336a, the processor 16 sorts the sets of sample characteristic values according to their similarity percentages to find one set of sample characteristic values having the maximum similarity percentage. After that, in step S340, the processor 16 determines an emotional state according to the set of sample characteristic values having the maximum similarity percentage. Finally, in step S350, the processor 16 stores a relationship between the emotional state and the set of sample characteristic values in the personal emotion database and the built-in emotion database.

Steps of how the processor 16 uses the built-in emotion database to recognize the voiceprint file are described in the following descriptions.

In step S332, the processor 16 compares the voiceprint file with a preset voiceprint to capture a plurality of characteristic values. Step S332 is similar to step S240 of the emotion recognizing method shown in FIG. 2, so details about step S332b can be referred to the above descriptions relevant to step S240 of the emotion recognizing method shown in FIG. 2. After that, in step S334b, the processor 16 compares the captured characteristic values with sets of sample characteristic values in the built-in emotion database and generates a similarity percentage. In this step, the types of the characteristic values the processor 16 captures from the voiceprint file are not restricted. In other words, the characteristic values the processor 16 captures from the voiceprint file can be the pitch, the formant, the frame energy and the like.

After that, the processor 16 determines whether the similarity percentage is larger than or equal to a threshold percentage. Specifically, the processor 16 determines whether there is one or more sets of sample characteristic values having a similarity percentage larger than or equal to the threshold percentage. If there is one set sample characteristic values having a similarity percentage larger than or equal to the threshold percentage, the processor 16 determines an emotional state according to the set of sample characteristic values. In addition, if there are more than one set of sample characteristic values having a similarity percentage larger than or equal to the threshold percentage, the processor 16 sorts the sets of sample characteristic values according to their similarity percentages to find one set of sample characteristic values having the maximum similarity percentage. After that, the processor 16 determines an emotional state according to the set of sample characteristic values having the maximum similarity percentage.

It is worth mentioning that, after the processor 16 determines an emotional state in step S340b, it goes to step S342. In step S342, the processor 16 generates an audio signal to make sure whether the emotional state determined in step S340b is exactly the emotional state of the individual. After that, if the processor 16 makes sure that the emotional state determined in step S340b is exactly the emotional state of the individual according to another voice signal received by the audio receiver 12, it goes to step S350. In step S350, the processor 16 stores a relationship between the emotional state and the set of characteristic values in the personal emotion database corresponding to the identification of the individual and the built-in emotion database. However, if the processor 16 cannot make sure that the emotional state determined in step S340b is exactly the emotional state of the individual according to another voice signal received by the audio receiver 12, it returns to step S340b. In step S340b, the processor 16 finds the set of sample characteristic value having the second largest similarity percentage and according determines another emotional state. After that, step S342 and step S350 are again executed.

On the other hand, in step S340b, if the processor 16 determines that there is no set of sample characteristic values having a similarity percentage larger than or equal to the threshold percentage, the processor 16 will still determines an emotional state according to one set of sample characteristic values having the maximum similarity percentage. After that, step S342 and step S350 are sequentially executed.

It is worth mentioning that, in step S334a and step S340b, the processor 16 compares the captured characteristic values with sets of sample characteristic values in the personal emotion database or in the built-in emotion database by using a Search Algorithm, and then determines the emotional state that the individual most probably has. In other words, the processor 16 uses the Search Algorithm to find one set of sample characteristic values in the personal emotion database or in the built-in emotion database, and the found set of sample characteristic values are most similar to the captured characteristic values. For example, the Search Algorithm used by the processor 16 can be the Sequential Search Algorithm, the Binary Search Algorithm, the Tree Search Algorithm, the Interpolation Search Algorithm, the Hashing Search Algorithm and the like. The Search Algorithm used by the processor 16 is not restricted herein.

[One Embodiment of the Smart Robot]

The smart robot provided in this embodiment includes a CPU and an emotion recognizing system provided in any of the above embodiments. For example, the smart robot can be implemented by a personal service robot or a domestic use robot. The emotion recognizing system provided in any of the above embodiments is configured in the smart robot, thus the smart robot can recognize the emotional state a user currently has according to a voice signal transmitted by the user. Additionally, after recognizing the emotional state the user currently has according to a voice signal transmitted by the user, the CPU of the smart robot generates a control instruction according to the emotional state recognized by the emotion recognizing system, such that the smart robot can execute a task according to the control instruction.

For example, when the user says “play music” in an upset tone, the emotion recognizing system of the smart robot can recognize the “upset” emotional state according to the voice signal transmitted by the user. Since the recognized emotional state is the “upset” emotional state, the CPU of the smart robot generates a control instruction such that the smart robot is controlled to transmit an audio signal, such as “would you like to have some soft music”, to know whether the user wants some soft music.

To sum up, in the emotion recognizing system and the emotion recognizing method provided by the present disclosure, the processor stores a relationship between the recognized emotional state and one set of characteristic values in both of the built-in emotion database and the personal emotion database. This is considered a learning function. Due to this learning function, the data amount of the personal emotion database and the built-in emotion database can be increased, and the data integrity of the personal emotion database and the built-in emotion database can be improved.

In addition, the emotion recognizing system and the emotion recognizing method provided by the present disclosure can quickly find a set of sample characteristic values in the personal emotion database or in the built-in emotion database, which is most similar to the captured characteristic values, by using a Search Algorithm.

Moreover, the emotion recognizing system, the emotion recognizing method and the smart robot provided by the present disclosure can recognize an emotional state a user currently has, so the smart robot can provide a service to the user or interact with the user based on the user's command and the user's current emotional state. Comparing with robot devices that can only provide a service to the user or interact with the user based on the user's command, services and responses provided by the smart robot in the present disclosure are much more touching and thoughtful.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. An emotion recognizing system, to recognize an emotional state according to a voice signal, comprising:
an audio receiver, receiving the voice signal;
a memory, storing a recognition program, a built-in emotion database, a plurality of personal emotion databases and a preset voiceprint database, wherein different personal emotion databases correspond to different individuals, and the preset voiceprint database stores a plurality of sample voiceprint and relationship between the sample voiceprint and identifications of different individuals; and
a processor, connected to the audio receiver and the memory, executing the recognition program to:
process the voice signal to obtain a voiceprint file, and recognize the identification of an individual that transmits the voice signal according to the voiceprint file;
determine whether a completion percentage of the personal emotion database corresponding to the identification of the individual is larger than or equal to a predetermined percentage, wherein the voiceprint file is recognized according to the personal emotion database if the completion percentage of the personal emotion database corresponding to the identification of the individual is larger than or equal to the predetermined percentage, and the voiceprint file is recognized according to the built-in emotion database if the completion percentage of the personal emotion database corresponding to the identification of the individual is smaller than or equal to the predetermined percentage;
compare the voiceprint file with a preset voiceprint to capture a plurality of characteristic values;
compare the characteristic values with sets of sample characteristic values in the personal emotion database or in the built-in emotion database and determine the emotional state, wherein different sets of the sample characteristic values correspond to different emotional states; and
store a relationship between the characteristic values and the emotional state in the personal emotion database and the built-in emotion database.

2. The emotion recognizing system according to claim 1, wherein the processor compares the characteristic values with the sets of the sample characteristic values in the personal emotion database or in the built-in emotion database by using a Search Algorithm, and determines the emotional state.

3. The emotion recognizing system according to claim 1, wherein when the processor recognizes the identification of the individual that transmits the voice signal according to the voiceprint file, the processor is further configured to:
determine whether the voiceprint file matches one of the sample voiceprints;
determine the individual that transmits the voice signal is the individual corresponding to the one of the sample voiceprints if the voiceprint file matches one of the sample voiceprints; and
add a relationship between the sample voiceprint and the identification of the individual into the preset voiceprint database and correspondingly build a personal emotion database in the memory if the voiceprint file does not match one of the sample voiceprints.

4. The emotion recognizing system according to claim 1, wherein when the processor compares the characteristic values with the sets of sample characteristic values in the personal emotion database, the processor is further configured to:
compare the characteristic values with the sets of sample characteristic values in the personal emotion database and accordingly generate a similarity percentage;
determine the emotional state according to one set of sample characteristic values if the similarity percentage is larger than or equal to a threshold percentage; and
compare the characteristic values with the sets of sample characteristic values in the built-in emotion database and accordingly determine the emotional state if the similarity percentage is smaller than the threshold percentage.

5. The emotion recognizing system according to claim 1, wherein after the processor compares the characteristic values with the sets of sample characteristic values in the built-in emotion database and accordingly determines the emotional state, the processor is further configured to:
generate an audio signal to determine whether currently the emotional state is actually the emotional state of the individual;
add a relationship between the sample voiceprint and the identification of the individual into the personal emotion database and the preset voiceprint database if currently the emotional state is actually the emotional state of the individual; and
again compare the characteristic values with the sets of sample characteristic values in the built-in emotion database and accordingly determine another emotional state if currently the emotional state is not the emotional state of the individual.

6. An emotion recognizing method, to recognize an emotional state according to a voice signal, adapted to an emotion recognizing system, wherein the emotion recognizing system includes an audio receiver, a memory and a processor, the audio receiver receives the voice signal, the memory stores a recognition program, a built-in emotion database, a plurality of personal emotion databases and a preset voiceprint database, different personal emotion databases correspond to different individuals, the preset voiceprint database stores a plurality of sample voiceprint and relationship between the sample voiceprint and identifications of different individuals, and the processor is connected to the audio receiver and the memory and executes the recognition program, comprising:
processing the voice signal to obtain a voiceprint file, and recognizing the identification of an individual that transmits the voice signal according to the voiceprint file;
determining whether a completion percentage of the personal emotion database corresponding to the identification of the individual is larger than or equal to a predetermined percentage, wherein the voiceprint file is recognized according to the personal emotion database if the completion percentage of the personal emotion database corresponding to the identification of the individual is larger than or equal to the predetermined percentage, and the voiceprint file is recognized according to the built-in emotion database if the completion percentage of the personal emotion database corresponding to the identification of the individual is smaller than or equal to the predetermined percentage;
comparing the voiceprint file with a preset voiceprint to capture a plurality of characteristic values;
comparing the characteristic values with sets of sample characteristic values in the personal emotion database or in the built-in emotion database and determining the emotional state, wherein different sets of the sample characteristic values correspond to different emotional states; and
storing a relationship between the characteristic values and the emotional state in the personal emotion database and the built-in emotion database.

7. The emotion recognizing method according to claim 6, wherein the processor compares the characteristic values with the sets of the sample characteristic values in the personal emotion database or in the built-in emotion database by using a Search Algorithm, and determines the emotional state.

8. The emotion recognizing method according to claim 6, wherein the step of recognizing the identification of the individual that transmits the voice signal according to the voiceprint file includes:
determining whether the voiceprint file matches one of the sample voiceprints;
determining that the individual that transmits the voice signal is the individual corresponding to the one of the sample voiceprints if the voiceprint file matches one of the sample voiceprints; and
adding a relationship between the sample voiceprint and the identification of the individual into the preset voiceprint database and correspondingly build a personal emotion database in the memory if the voiceprint file does not match one of the sample voiceprints.

9. The emotion recognizing method according to claim 6, wherein the step of comparing the characteristic values with the sets of sample characteristic values in the personal emotion database includes:
comparing the characteristic values with the sets of sample characteristic values in the personal emotion database and accordingly generating a similarity percentage;
determining the emotional state according to one set of sample characteristic values if the similarity percentage is larger than or equal to a threshold percentage; and
comparing the characteristic values with the sets of sample characteristic values in the built-in emotion database and accordingly determining the emotional state if the similarity percentage is smaller than the threshold percentage.

10. The emotion recognizing method according to claim 6, wherein after the step of comparing the characteristic values with the sets of sample characteristic values in the built-in emotion database and accordingly determining the emotional state, the emotion recognizing method comprises:
generating an audio signal to determine whether currently the emotional state is actually the emotional state of the individual;
adding a relationship between the sample voiceprint and the identification of the individual into the personal emotion database and the preset voiceprint database if currently the emotional state is actually the emotional state of the individual; and
again comparing the characteristic values with the sets of sample characteristic values in the built-in emotion database and accordingly determining another emotional state if currently the emotional state is not the emotional state of the individual.

11. A smart robot, comprising:
a CPU; and
an emotion recognizing system according to claim 1, recognizing an emotional state according to a voice signal;
wherein the CPU generates a control instruction according to the emotional state recognized by the emotion recognizing system such that the smart robot executes a task according to the control instruction.
